(19) United States
(12) Patent Application Publication
(10) Pub. No.: US 2011/0216342 A1
(43) Pub. Date: Sep. 8, 2011

(54) IMAGE PROCESSING DEVICE AND IMAGE PROCESSING METHOD

(75) Inventor: Naoya Murakami, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/041,725

(22) Filed: Mar. 7, 2011

Related U.S. Application Data
(60) Provisional application No. 61/311,559, filed on Mar. 8, 2010.

(51) Int. Cl. G06F 15/00

(52) U.S. Cl. 358/1.13

(57) ABSTRACT

According to one embodiment, an image processing device includes a reading unit, an image processing unit, a display unit, and an instruction unit. The reading unit reads an image from an image reading region on a platen. The image processing unit detects non-document image data from read image data obtained by the reading and generates estimated document image data by removing the non-document image data from the read image data. The display unit displays an estimated document image based on the estimated document image data. The instruction unit receives one instruction of a reprocessing instruction for remaking the estimated document image data and the next processing instruction for instructing the next process without remaking the estimated document image data, in response to the display of the estimated document image.

### CROSS-REFERENCE TO RELATED APPLICATIONS

This application is based upon and claims the benefit of priority from U.S. Provisional Application No. 61/311,559, filed on Mar. 8, 2010; the entire contents of which are incorporated herein by reference.

### FIELD

Embodiments described herein relate generally to an image processing device and an image processing method.

### BACKGROUND

In recent years, image processing devices having various functions have appeared. For example, an image processing device reads an image from an image reading region on a platen, thereby obtains read image data, and determines a document image region and a non-document image region (unnecessary image region) included in the read image data based on binary data corresponding to the read image data. In addition, the image processing device removes non-document image data (unnecessary image data) corresponding to the non-document image region from the read image data. In this way, the image processing device can generate document image data from read image data and form a document image based on the document image data.

### BRIEF DESCRIPTION OF THE DRAWINGS

FIG. 1A and FIG. 1B are diagrams illustrating an example of a read image including a document image and a non-document image (unnecessary image).

FIGS. 1C and 1D are diagrams illustrating an example of an estimated document image after a non-document region is removed.

FIG. 2 is a flowchart illustrating an example of an image process (document reading process).

FIG. 3 is a diagram illustrating an example of a schematic configuration of a non-document part removing unit of an image processing device according to an embodiment.

FIG. 4 is a diagram illustrating an example of a main configuration of the image processing device according to an embodiment.

FIG. 5 is a diagram illustrating an example of a schematic configuration of the respective units of the image processing device according to an embodiment.

FIG. 6 is a diagram illustrating an example of a screen for setting parameters for processing a non-document part.

FIG. 7 is a diagram illustrating an example of an image reading region on a platen.

FIG. 8 is a diagram illustrating a display example of an estimated document image (preview of a document image) and various kinds of keys on a control panel.

FIG. 9 is a diagram illustrating a display example of an estimated document image (preview of a document image) and various kinds of keys on a control panel.

FIG. 10 is a diagram illustrating a display example of an estimated document image (preview of a document image) and a screen for setting parameter for processing a non-document part on the control panel.

FIG. 11 is a diagram illustrating an example of a document cover of the image processing device according to an embodiment.

### DETAILED DESCRIPTION

In general, according to one embodiment, an image processing device includes a reading unit, an image processing unit, a display unit, and an instruction unit. The reading unit reads an image from an image reading region on a platen. The image processing unit detects non-document image data from the read image data obtained by the reading unit, and generates estimated document image data by removing the non-document image data from the read image data. The display unit displays an estimated document image based on the estimated document image data. In response to the display of the estimated document image, the instruction unit receives either a reprocessing instruction for remaking the estimated document image data or the next processing instruction for instructing the next process without remaking the estimated document image data.

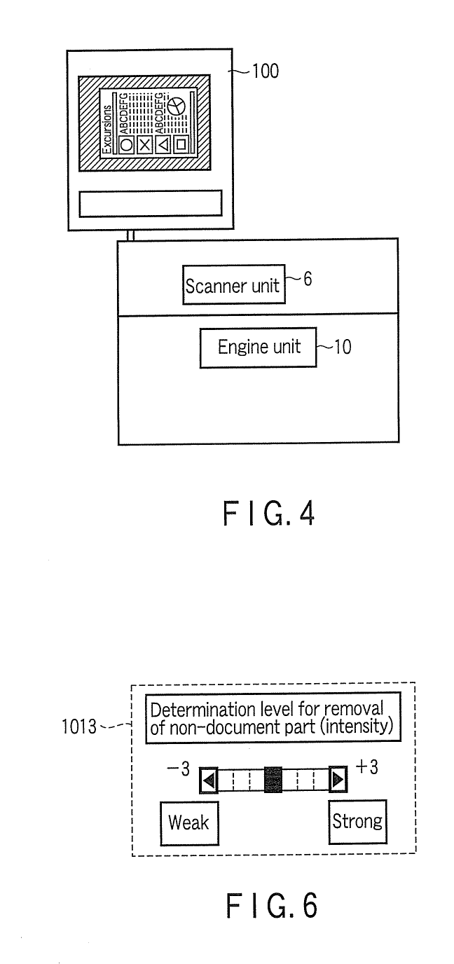

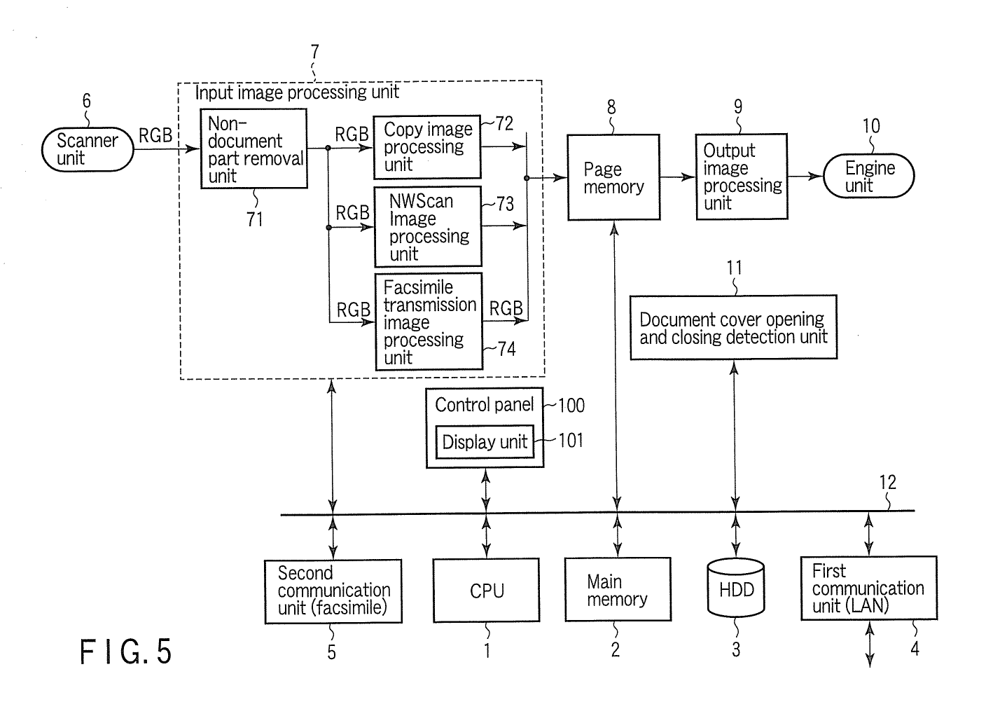

FIG. 4 is a diagram illustrating an example of a main configuration of the image processing device according to the embodiment. In addition, FIG. 5 is a diagram illustrating a schematic configuration of the respective units of the image processing device shown in FIG. 4. As shown in FIGS. 4 and 5, the image processing device includes a CPU (control unit) 1, a main memory 2, an HDD (storage unit) 3, a first communication unit (LAN) 4, a second communication unit (facsimile) 5, a scanner unit (an image reading unit) 6, an input image processing unit 7, a page memory 8, an output image processing unit 9, an engine unit 10, a document cover opening and closing detection unit 11, and a system bus 12. The CPU 1 is connected to the respective units via the system bus 12, and receives information from the respective units, or instructs the respective units to perform various processes.

Next, an image process (a document reading process) in the image processing device will be described.

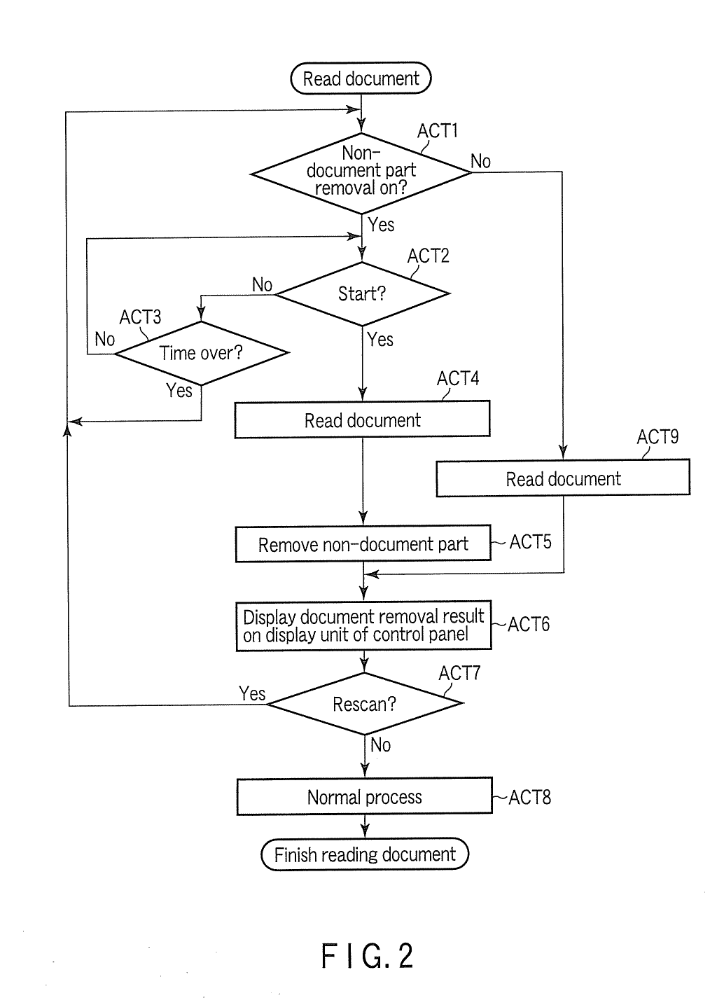

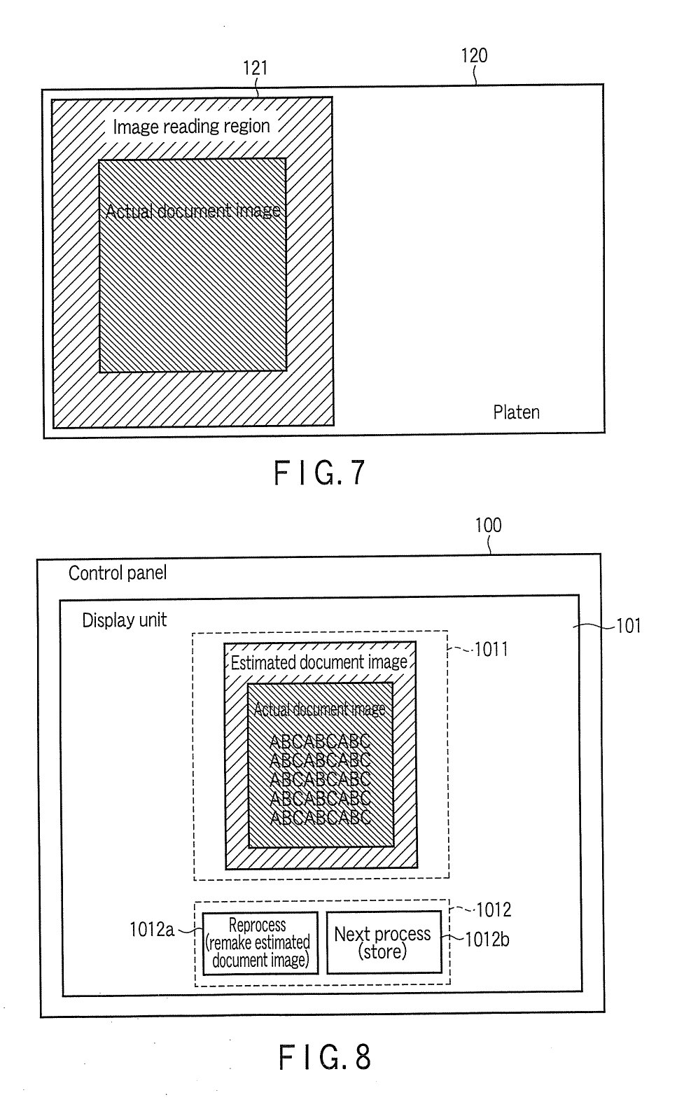

For example, the removal of a non-document part is designated using a non-document part removal designating key or the like on a control panel 100 (ACT 1, YES, in FIG. 2), within a limited time (ACT 2, NO→ACT 3, NO, in FIG. 2), if image reading is designated using a start key or the like on the control panel 100 (ACT 2, YES, in FIG. 2), the scanner unit 6 reads an image from an image reading region 121 on a platen 120 shown in FIG. 7.

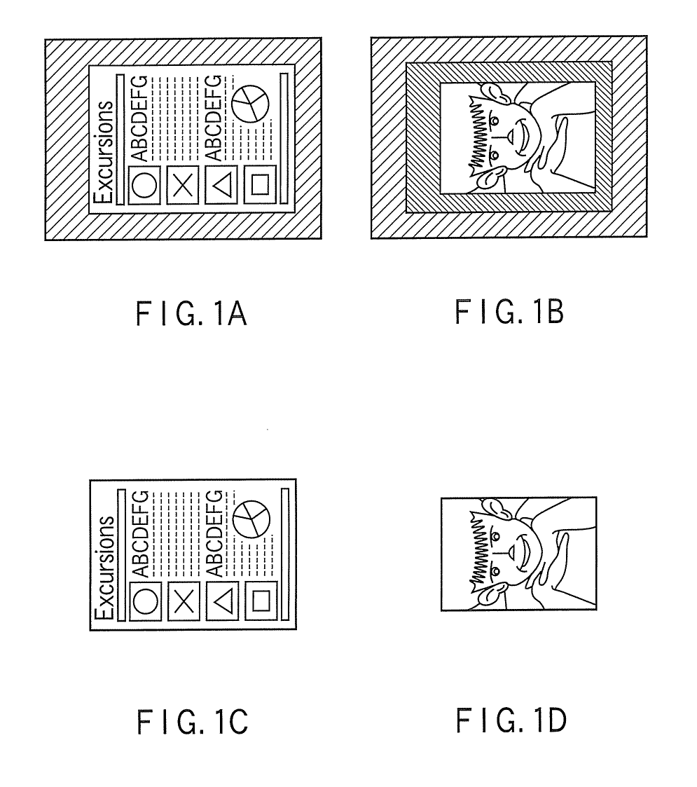

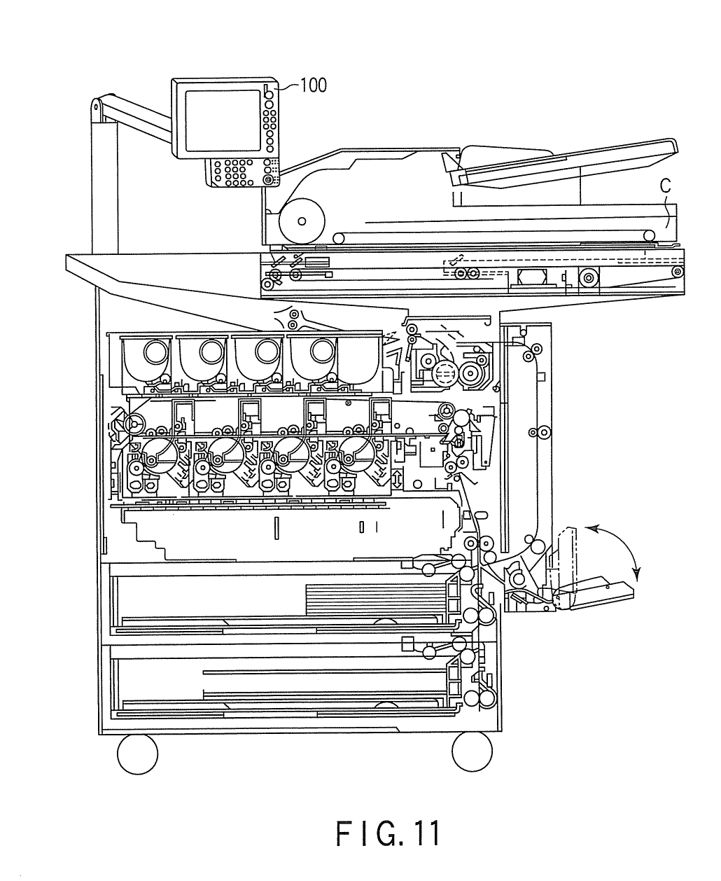

For example, in a state where a document cover C (platen cover) shown in FIG. 11 does not block external light from reaching the platen 120 (state where the document cover is open), an image read from the image reading region 121 may include a non-document image (unnecessary image) as well as a document image as shown in FIGS. 1A and 1B.

If the non-document part removal is designated, the input image processing unit 7 (non-document part removal unit 71) removes the non-document part (ACT 5 in FIG. 2). In response to the non-document part removal, the input image processing unit 7 (the non-document part removal unit 71) analyzes a feature amount (for example, a density distribution) for read image data which is obtained through the image reading in the scanner unit 6, and detects non-document image data from the read image data. Successively, the input image processing unit 7 (the non-document part removal unit 71) removes the non-document image data from the read image data and generates estimated document image data. For example, the input image processing unit 7 (the non-document part removal unit 71) converts the non-document image data included in the read image data into data corresponding to a white paper and generates the estimated document image data. In addition, the HDD 3 stores (temporarily stores) the estimated document image data generated.

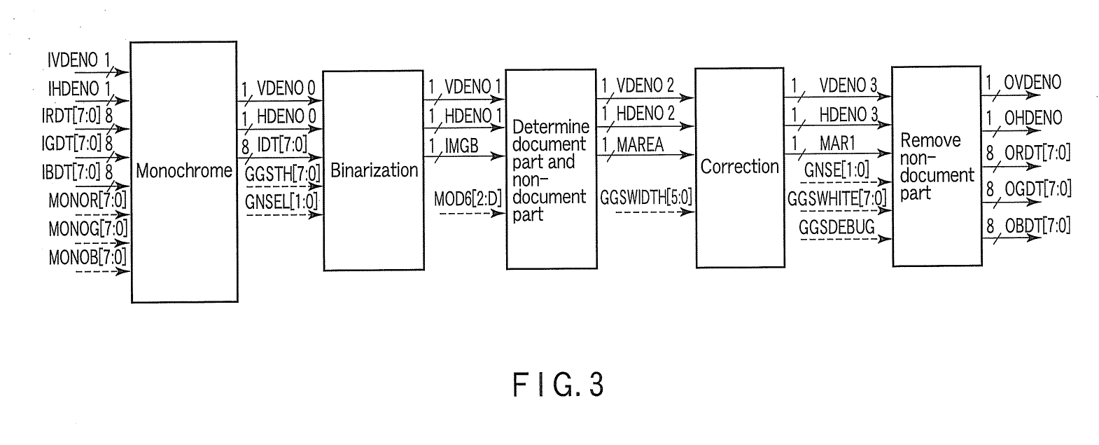

FIG. 3 is a diagram illustrating an example of a schematic configuration of the non-document part removal unit 71. The non-document part removal unit 71 generates binary image data corresponding to read image data obtained through image reading in the scanner unit 6, determines a document image region (document image data) and a non-document image region (non-document image data) from the binary image data, and generates estimated document image data by removing the non-document image data from the binary image data.

In addition, a technique regarding the non-document part removal is disclosed in U.S. Pat. No. 3,786,213/U.S. Pat. No. 5,629,777, and it is assumed that the present image processing device performs the non-document part removal using this technique, for example.

FIG. 1C or 1D is a diagram illustrating an example of the estimated document image generated from the read image shown in FIG. 1A or 1B. FIG. 10 shows an example of a relatively good estimated document image and FIG. 1D shows an example of an unsuitable estimated document image generated after the non-document image data is excessively removed from the read image data. In addition, when the non-document image data is not sufficiently removed from the read image data as well, an unsuitable estimated document image is generated.

In the read image shown in FIG. 1B, a black image region in a document (in a picture) and a black image region in a non-document part (in a picture exclusion part) are continuous. For this reason, the input image processing unit 7 (the non-document part removal unit 71) erroneously determines the black image region in the document (in the picture) included in the read image data shown in FIG. 1B as the non-document image, and as a result, may generate an estimated document image by excessively removing the non-document image data from the read image data.

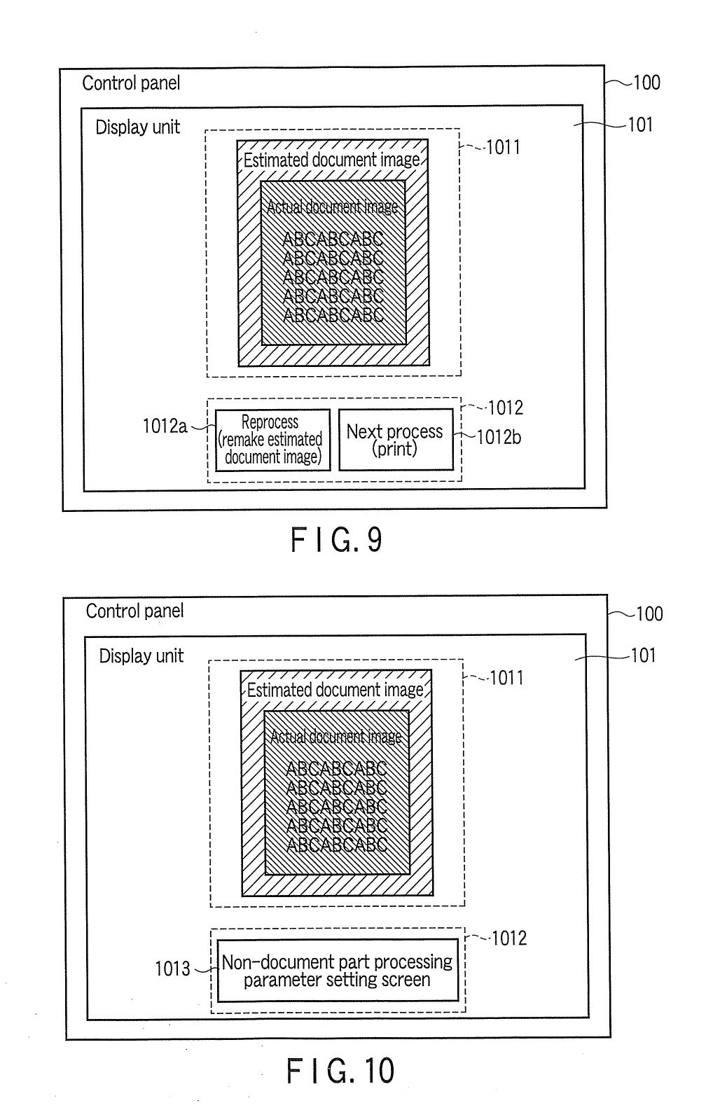

The non-document part removal is performed in response to the designation of the non-document part removal as described above, a display unit 101 of the control panel 100 displays an estimated document image (preview of the document image) based on the estimated document image data on a display region 1011 as shown in FIG. 8 or 9 (ACT 6 in FIG. 2).

In addition, the display unit 101 of the control panel 100 displays a first key 1012a and a second key 1012b on a display region 1012 so as to correspond to the display of the estimated document image as shown in FIG. 8 or 9. The first key 1012a is a key for receiving a reprocessing instruction for remaking the estimated document image data. In addition, the second key 1012b is a key for receiving the next processing instruction for instructing the next process without remaking the estimated document image data.

The control panel 100 receives either of the reprocessing instruction and the next processing instruction via either of the first key 1012a and the second key 1012b. For example, the display unit 101 displays the first key 1012a with first brightness and displays the second key 1012b with the first brightness in the same manner. At this time, a user may select either the first key 1012a or the second key 1012b.

For example, if the first key 1012a is selected, the display unit 101 changes the brightness for the second key 1012b and displays the second key 1012b with second brightness darker than the first brightness, thereby providing guidance that the second key 1012b cannot be selected. In the same manner, if the second key 1012b is selected, the display unit 101 changes the brightness for the first key 1012a and displays the first key 1012a with second brightness darker than the first brightness, thereby guiding that the first key 1012a cannot be selected.

For example, if a user is not satisfied with the estimated document image (preview of the document image) (if the non-document part is excessively or insufficiently removed), the user may select the first key 1012a. If the first key 1012a is selected, the control panel 100 instructs reprocessing, the CPU 1 performs remake of estimated document image data in response thereto, and the input image processing unit 7 (the non-document part removal unit 71) remakes the estimated document image data in response thereto.

For example, the input image processing unit 7 (the non-document part removal unit 71) detects first non-document image data from the read image data, and generates first estimated document image data by removing the first non-document image data from the read image data, based on a first non-document part processing parameter (non-document part processing parameter set initially) before receiving the reprocessing instruction. In response thereto, the display unit 101 of the control panel 100 displays a first estimated document image based on the first estimated document image data.

In addition, after receiving the reprocessing instruction (that is, if the first key 1012a is selected), the input image processing unit 7 (the non-document part removal unit 71) detects second non-document image data from the read image data and generates second estimated document image data by removing the second non-document image data from the read image data based on a second non-document part processing parameter. In response thereto, the display unit 101 of the control panel 100 displays a second estimated document image based on the second estimated document image data instead of the first estimated document image.

Further, if the first key 1012a is selected, the display unit 101 of the control panel 100 may display a non-document part processing parameter setting screen 1013 on the display region 1012 as shown in FIG. 10. FIG. 6 is a diagram illustrating an example of the non-document part processing parameter setting screen 1013 displayed on the display region 1012. The user changes the magnitude of a non-document part determination level (non-document part processing parameter) via the non-document part processing parameter setting screen 1013, and, can obtain an ideal estimated document image by, for example, setting the above-described second non-document part processing parameter. For example, the first non-document part processing parameter is a parameter used to determine a region in which pixels having a density higher than a first density level occur very frequently as a non-document image, and the second non-document part processing parameter is a parameter used to determine a region in which pixels having a density higher than a second density level higher than the first density level occur very frequently as a non-document image.

In addition, after the above-described second non-document part processing parameter is set, the scanner unit 6 may reread an image from the image reading region 121 on the platen 120 shown in FIG. 7 (ACT 7, YES, in FIG. 2). Thereby, the input image processing unit 7 (the non-document part removal unit 71) detects second non-document image data from read image data obtained through the image rereading in the scanner unit 6 and generates second estimated document image data by removing the second non-document image data from the read image data, based on the second non-document part processing parameter. In response thereto, the display unit 101 of the control panel 100 displays a second estimated document image (preview of the document image) based on the second estimated document image data. That is, the display unit 101 of the control panel 100 replaces the first estimated document image, which is displayed, based on the first estimated document image data, with the second estimated document image based on the second estimated document image data.

In addition, if the user is satisfied with the estimated document image (preview of the document image) (if the non-document image is appropriately removed), the user may select the second key 1012b. If the second key 1012b is selected, the control panel 100 instructs the next process (normal process), and, in response thereto, the CPU 1 performs the next process (normal process) (ACT 8 in FIG. 2).

For example, as shown in FIG. 8, the second key 1012b is a key for receiving an instruction for changing the temporary storage of the estimated document image data to the formal storage. Therefore, if the second key 1012b is selected, the CPU 1 instructs the temporary storage of the estimated document image data to be changed to the formal storage, and, the estimated document image data which is temporarily stored in the HDD 3 is formally stored in response thereto.

Alternatively, as shown in FIG. 9, the second key 1012b is a key for receiving an instruction for forming an image based on the estimated document image data. Therefore, if the second key 1012b is selected, the CPU 1 instructs an image to be formed based on the estimated document image data, and, in response thereto, the output image processing unit 9 and the engine unit 10 form an image based on the estimated document image data.

In addition, if the non-document part removal is not designated (ACT 1, NO, in FIG. 2), in response to an instruction for reading an image, the scanner unit 6 reads an images from the image reading region 121 on the platen 120 shown in FIG. 7 (ACT 9 in FIG. 2), the non-document part removal is not performed, and the display unit 101 of the control panel 100 displays a read image (preview of the read image) based on the read image data (ACT 6 in FIG. 2). In addition, the display unit 101 of the control panel 100 displays the key for receiving the reprocessing instruction and the key for receiving the next processing instruction, and receives either the reprocessing instruction or the next processing instruction.

If receiving the reprocessing instruction, the scanner unit 6 reads again an image from the image reading region 121 on the platen 120 shown in FIG. 7, the non-document part removal is not performed, and the display unit 101 of the control panel 100 displays a read image (preview of the read image) based on the read image data.

If the next processing instruction is received, for example, the CPU 1 instructs the read image data to be formally stored, and, in response thereto, the read image data is formally stored in the HDD 3. Alternatively, if the next processing instruction is received, for example, the CPU 1 instructs an image to be formed based on the read image data, and, in response thereto, the output image processing unit 9 and the engine unit 10 form an image based on the read image data.

Next, a supplemental explanation will be given concerning the document cover C and detection of the opening and closing of the document cover.

For example, the document cover C shown in FIG. 11 is integrally formed with an automatic document feeder. The automatic document feeder extracts documents set in a reading document placing section so as to be carried, sets a document at a read position in the platen 120, carries the document set at the read position after the document is read, and places the document on a place where a read document is placed. In addition, the document cover C can be opened and closed with respect to the platen 120.

The document cover opening and closing detection unit 11 detects the open and closed state of the document cover C. For example, the document cover opening and closing detection unit 11 detects a state where the document cover C does not block external light from reaching the platen 120 (a document cover open state), and notifies the CPU 1 of the document cover open state. Responding thereto, the CPU 1 designates the non-document part removal. In this case, the non-document part removal is designated even if there is no designation of non-document part removal via the non-document part removal designating key of the control panel 100. In other words, in the open state of the document cover C, the non-document part removal is automatically designated. That is, in the open state of the document cover C, if image reading is designated and an image is read, the input image processing unit 7 (non-document part removal unit 71) performs the removal process and generates an estimated document image. The display unit 101 of the control panel 100, as shown in FIG. 8 or 9, displays an estimated document image (preview of the document image) based on the estimated document image data on the display region 1011.

In addition, the document cover opening and closing detection unit 11 detects a state where the document cover C blocks external light from reaching the platen 120 (document cover closed state), and notifies the CPU 1 of the document cover closed state. Responding thereto, the CPU 1 designates the next process (normal process). In this case, the next process is designated even if there is no instruction for the next process via the above-described second key 1012b. In other words, in the closed state of the document cover C, the next process is automatically designated. That is, in the closed state of the document cover C, if image reading is designated and an image is read, the input image processing unit 7 (the non-document part removal unit 71) does not perform the removal process. The display unit 101 of the control panel 100 displays the read image, and the read image data is sequentially (automatically) and formally stored in the HDD 3. Alternatively, in the closed state of the document cover C, if image reading is designated and an image is read, the input image processing unit 7 (the non-document part removal unit 71) does not perform the removal process. The display unit 101 of the control panel 100 displays the read image, and the output image processing unit 9 and the engine unit 10 sequentially (automatically) form an image based on the read image data.

Hereinafter, the above-described image process (document reading process) in the image processing device will be summarized.

For example, if an image is read in the document cover open state, the image processing device displays an estimated document image from which a non-document image is removed and receives either reprocessing or the next process, and if receiving the reprocessing, recreates a more appropriate estimated document image and redisplays the formed image. In addition, if receiving the next process, the image processing device formally stores estimated document image data or forms an images based on the estimated document image data.

Thereby, even in a case where a document having a background color close to black, such as dark blue or violet, and unsuitable estimated document image data may be generated due to the non-document part removal processing, the image processing device does not automatically perform a process based on the unsuitable estimated document image data. Therefore, if a user is not satisfied with an estimated document image (preview of the document image), it is possible to remake estimated document image data through rescanning and to prevent waste caused by a process based on the unsuitable estimated document image data.

In addition, a recent image processing device may be provided with a large size control panel (large size display unit), and it is possible to effectively use the large size control panel (large size display unit).

In addition, in the above description, although the case where either of reprocessing and the next process can be selected has been described, one of reprocessing, the next process, and job cancellation may be selected. Also, one of a reprocessing, the next process, scanning the next document may be selected.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing device comprises:
a reading unit that reads an image from an image reading region on a platen;
an image processing unit that detects non-document image data from read image data obtained by the reading and generates estimated document image data by removing the non-document image data from the read image data;
a display unit that displays an estimated document image based on the estimated document image data; and
an instruction unit that receives one instruction of a reprocessing instruction for remaking the estimated document image data and a next processing instruction for instructing a next process without remaking the estimated document image data, in response to the display of the estimated document image.

2. The device according to claim 1, further comprising a control unit that remakes the estimated document image data in response to the reprocessing instruction and performs the next process in response to the next processing instruction.

3. The device according to claim 1, wherein the image processing unit detects first non-document image data from the read image data based on a first non-document part processing parameter before receiving the reprocessing instruction, and detects second non-document image data from the read image data based on a second non-document part processing parameter after receiving the reprocessing instruction.

4. The device according to claim 3, wherein the image processing unit generates first estimated document image data by removing the first non-document image data from the read image data and generates second estimated document image data by removing the second non-document image data from the read image data.

5. The device according to claim 4, wherein the display unit displays a first estimated document image based on the first estimated document image data so as to correspond to the generation of the first estimated document image data, and displays a second estimated document image based on the second estimated document image data instead of the first estimated document image so as to correspond to the generation of the second estimated document image data.

6. The device according to claim 3, wherein the instruction unit receives a parameter changing instruction for changing the first non-document part processing parameter to the second non-document part processing parameter, and the image processing unit detects the second non-document image data from the read image data based on the second non-document part processing parameter after receiving the parameter changing instruction and also receiving the reprocessing instruction.

7. The device according to claim 1, wherein the reading unit rereads the image from the image reading region in response to the reprocessing instruction, and the image processing unit detects non-document image data from the reread image data obtained by the rereading in response to the reprocessing instruction.

8. The device according to claim 1, wherein the instruction unit displays a first key used to receive the reprocessing instruction and a second key used to receive the next processing instruction in response to the display of the estimated document image and receives an instruction from one key of the first and second keys.

9. The device according to claim 3, wherein the instruction unit displays a first key used to receive the reprocessing instruction and a second key used to receive the next processing instruction in response to the display of the estimated document image, receives an instruction from one key of the first and second keys, and displays a third key used to receive the parameter changing instruction in response to the reception of the reprocessing instruction from the first key.

10. The device according to claim 8, wherein the instruction unit displays the second key used to receive an instruction for storing the estimated document image data.

11. The device according to claim 10, further comprising a storage unit that stores the estimated document image data in response to the instruction for the storage.

12. The device according to claim 8, wherein the instruction unit displays the second key used to receive an instruction for forming an image based on the estimated document image data.

13. The device according to claim 12, further comprising an image forming unit that forms the estimated document image based on the estimated document image data in response to the instruction for forming an image.

14. The device according to claim 1, further comprising:
a document cover that can be opened and closed with respect to the platen; and
a detection unit that detects open and closed states of the document cover with respect to the platen,
wherein the display unit displays the estimated document image in response to the detection of the open state.

15. The device according to claim 14, wherein the display unit displays the estimated document image in response to the detection of the open state, and
wherein the instruction unit displays a first key used to receive the reprocessing instruction and a second key used to receive the next processing instruction in response to the display of the estimated document image and receives an instruction from one key of the first key and the second key.

16. The device according to claim 13, further comprising a control unit that performs the next process in response to the detection of the closed state.

17. An image processing device comprises:
a reading means for reading an image from an image reading region on a platen;
an image processing means detecting non-document image data from read image data obtained by the reading and generates estimated document image data by removing the non-document image data from the read image data;
a display means for displaying an estimated document image based on the estimated document image data; and
an instruction means for receiving one instruction of a reprocessing instruction for remaking the estimated document image data and the next processing instruction for instructing the next process without remaking the estimated document image data, in response to the display of the estimated document image.

18. An image processing method comprises:
reading an image from an image reading region on a platen;
detecting non-document image data from read image data obtained by the reading;
generating estimated document image data by removing the non-document image data from the read image data;
displaying an estimated document image based on the estimated document image data; and
receiving one instruction of a reprocessing instruction for remaking the estimated document image data and a next processing instruction for instructing a next process without remaking the estimated document image data, in response to the display of the estimated document image.
